(19) United States
(12) Patent Application Publication
(10) Pub. No.: US 2012/0324236 A1
(43) Pub. Date: Dec. 20, 2012

(54) Trusted Snapshot Generation

(75) Inventors: Abhinav Srivastava, Atlanta, GA (US); Himanshu Raj, Issaquah, WA (US); Paul England, Bellvue, WA (US); Parag Sharma, Issaquah, WA (US)

(73) Assignee: MICROSOFT CORPORATION, Redmond, WA (US)

(21) Appl. No.: 13/161,520

(22) Filed: Jun. 16, 2011

(51) Int. Cl. G06F 21/24

(52) U.S. Cl. 713/189

(57) ABSTRACT

A hypervisor provides a snapshot protocol that generates a verifiable snapshot of a target machine. The verifiable snapshot includes a snapshot and a signed quote. In one implementation, a challenger requests a snapshot of the target machine. In response to the snapshot request, the hypervisor initiates Copy-on-Write (CoW) protection for the target machine. The hypervisor snapshots and hashes each of the memory pages and the virtual central processing unit (CPU) of the target machine. The hypervisor generates a composite hash by merging all individual memory page hashes and the CPU state hash. The hypervisor requests a quote including integrity indicators of all trusted components and the composite hash. The quote uses a cryptographic signature from a trusted platform module, which ensures that any compromise of the integrity of the snapshot is detectable. The snapshot and signed quote are returned to the challenger for verification.

### BACKGROUND

Many modern computing environments provide a virtualization of hosted computing systems, for example, with a cloud infrastructure. In such virtualization environments, a hypervisor permits multiple operating systems (e.g., inside guest virtual machines) to run concurrently on a host system (e.g., a privileged virtual machine). However, there is a lack of verifiable trust between a customer and a virtualized infrastructure provider, and customers generally relinquish control of the code, data, and computation associated with a guest virtual machine.

A customer could obtain a snapshot of the runtime state of a virtual machine in the virtualized infrastructure to establish trust in the virtualization environment. However, many virtualization environments provide the snapshot from a privileged virtual machine, which may be compromised or have malicious administrators. Because a privileged virtual machine runs a substantially large operating system and a set of user-level tools with elevated privileges, vulnerabilities present in the privileged virtual machine may be exploited by attackers (e.g., malicious administrators) or malware to compromise the integrity of a snapshot module or a snapshot file. Accordingly, there remains a lack of trust in the integrity of a snapshot in a virtualization environment.

### SUMMARY

Implementations described and claimed herein address the foregoing problems by providing a snapshot protocol that allows a challenger to obtain verifiable snapshots of virtual machines executing in a virtualization environment and that requires minimal trust in the virtualized infrastructure. In one implementation, a hypervisor comprises a trusted computing base (TCB) of the virtualized infrastructure. A challenger may request a snapshot of a target virtual machine including but not limited to a guest virtual machine and a privileged virtual machine. In response to the snapshot request, the hypervisor pauses the target virtual machine to initiate Copy-on-Write (CoW) protection for the target virtual machine, which write-protects the address space of the target virtual machine against access from any entity other than the hypervisor. Modifications to the page table of the target machine are allowed after affected CoW pages are copied. The hypervisor resumes the execution of the target virtual machine. Any write request to a write-protected page in the address space of the target virtual machine constitutes an access fault. At each access fault on a write-protected page, the hypervisor copies the memory content of the faulted page and computes and stores a hash of the contents of the faulted page before restoring write access permissions. A snapshot module copies each of the memory pages of the target virtual machine to generate a snapshot. In one implementation, the virtual central processing unit (CPU) state associated with the target virtual machine is additionally copied to the snapshot file. The hypervisor generates a composite hash of the snapshot by merging all individual memory page hashes, associated with an access fault or the memory pages of the target virtual machine, and the CPU state hash. The hypervisor requests a quote from a trusted platform module (TPM) including integrity indicators of all trusted components (e.g., the hypervisor) and the composite hash of the snapshot of the target virtual machine. The quote uses a cryptographic signature from the TPM, which ensures that any compromise of the integrity of the snapshot is detectable. The snapshot and signed quote are returned to the challenger.

In one implementation, the snapshot generation is decoupled from the snapshot verification. The challenger receives the snapshot and verifies the integrity of the snapshot generation with the integrity indicators of the trusted components and the composite hash of the snapshot of the target virtual machine. Adequate values of the integrity indicators verify the signature on the snapshot and that the integrity of the hypervisor was maintained during the snapshot generation. A final composite hash is computed over the memory contents contained in the snapshot. An integrity measure for the final composite hash is compared to the integrity measure for the composite hash of the snapshot of the target virtual machine. If the integrity measure of the final composite hash matches the integrity measure of the composite hash of the snapshot of the target virtual machine, the snapshot received by the challenger is trusted.

In some implementations, articles of manufacture are provided as computer program products. One implementation of a computer program product provides a tangible computer program storage medium readable by a computing system and encoding a processor-executable program. Other implementations are also described and recited herein.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 illustrates an example virtualized infrastructure.

FIG. 2 illustrates an example virtualized infrastructure for generating a verifiable snapshot.

FIG. 3 illustrates example operations for generating a verifiable snapshot.

FIG. 4 illustrates example operations for verifying the integrity of a snapshot.

FIG. 5 illustrates an example system that may be useful in implementing the technology described herein.

### DETAILED DESCRIPTION

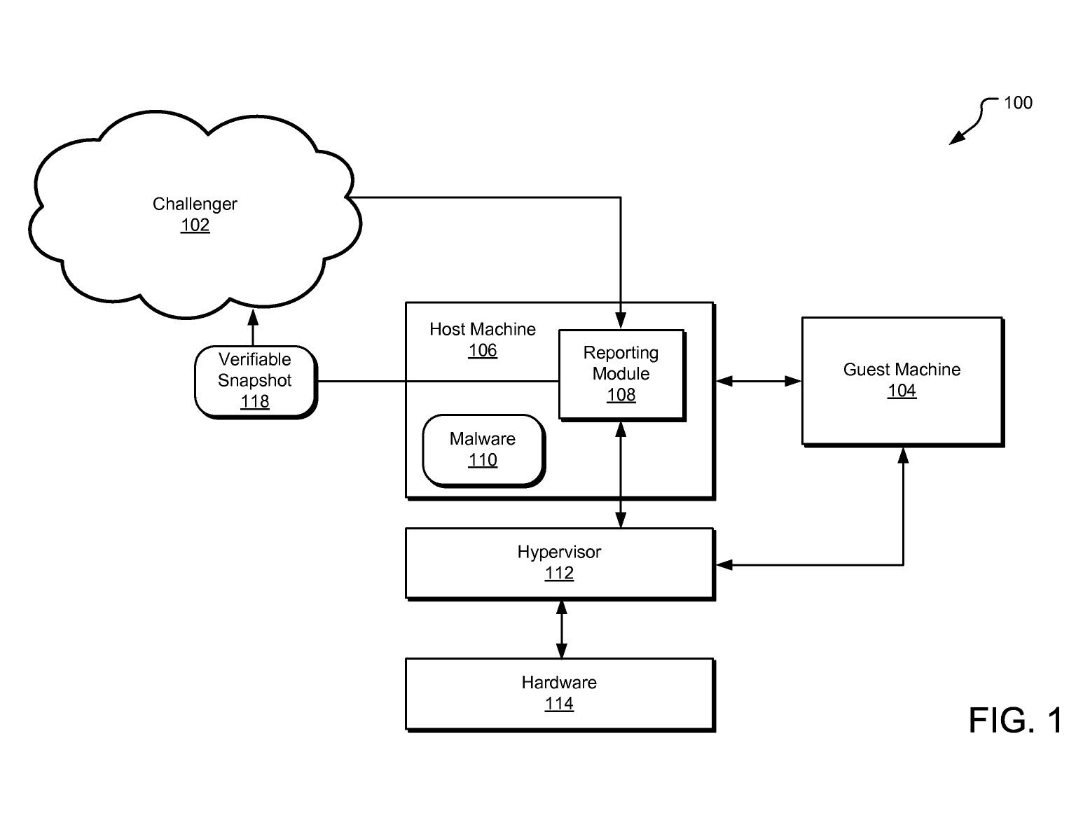

FIG. 1 illustrates an example virtualized infrastructure 100. Although the example implementation is a virtualization environment, it should be understood that the technology disclosed herein may be used in various applications relating to generating authoritative reports of the state of an entity via an entity running with a higher privilege level. For example, the presently disclosed technology may be used in gaming applications, security applications, etc.

The virtualized infrastructure 100 includes one or more guest virtualized machines (e.g., a guest machine 104) and one or more privileged virtual machines (e.g., a host machine 106). A virtual machine provides a virtual environment in which to run an operating system, implemented by software emulation or hardware virtualization. The guest machine 104 may be associated with a customer of a provider of virtualization services (e.g., cloud computing), and administrators of the provider may control the host machine 106.

The host machine 106 may be, for example, a root virtual machine, which provides services to the guest machine 104 including without limitation startup, snapshotting, memory and CPU resource management, I/O virtualization, peripheral access, save/restore, and live migration. The guest machine 104 is a virtual machine running for a specific purpose, for example, as a virtual workload managed by the host machine 106. A hypervisor 112 is a virtual machine monitor that isolates each guest virtual machine from another, allowing multiple guest virtual machines to operate concurrently on the host 106. Additionally, the hypervisor 112 manages access to hardware 114 associated with the provider of the virtualization services.

In public virtualization environments, a customer generally relinquishes control over the code, data, and computation of the guest machine 104 to the host 106, which makes the guest machine 104 vulnerable where the host 106 and/or the administrators of the provider are compromised. To establish trust in the virtualized infrastructure 100, a challenger 102 may request a report of a runtime state of a virtual machine running in the virtualized infrastructure 100 at a given time.

In one implementation, the challenger 102 is a customer requesting a report of the runtime state of the guest machine 104. In another implementation, the challenger 102 is a provider requesting a report of the runtime state of the host machine 106. In yet another implementation, the challenger 102 is a third party requesting a report of the runtime state of a virtual machine to ensure that a client of the third party is not using resources that are compromised (e.g., a bank ensuring that it is transacting with a client rather than malware or an attacker).

The runtime state of a target virtual machine is captured via a snapshot. The snapshot may be used, for example, for runtime integrity measurement, forensic analysis, migration, recovery, malware detection, correctness validation, debugging, virtual machine health management, or other runtime analysis. However, the integrity of the snapshot may be subverted where the contents of the snapshot and/or the snapshot generation process are compromised. For example, malware or a malicious administrator may perpetrate an attack from a compromised host including but not limited to tampering, reordering, replaying, and/or masquerading. During a tampering attack, the compromised host modifies the contents of the snapshot and/or modifies the runtime memory and CPU state of the target virtual machine during the snapshot generation process to remove evidence of malware or improper activity. A reordering attack occurs when the compromised host reorders the content of the memory pages in the snapshot without modifying the contents of individual memory pages. A reordering attack may result in a failure of forensic analysis utilities to locate security-relevant data in the snapshot. The compromised host performs a replaying attack by providing an old snapshot of the target virtual machine that does not contain any malicious components. Finally, during a masquerading attack, the compromised host intercepts a snapshot request and modifies the parameters of the request to provide a snapshot of a virtual machine different from the target virtual machine.

To address a potential attack from a compromised host and establish trust in the virtualization environment, the virtualized infrastructure 100 excludes the host machine 106 from the trusted computing base (TCB) of the virtualization environment. A trusted computing base is the set of all entities that are critical to the security of a computing system or infrastructure. Hardware (e.g., the hardware 114) may be inherently trusted. Accordingly, an infrastructure is trustworthy where it is based on a trust chain that is rooted in hardware.

The trusted computing base of the virtualized infrastructure 100 includes the hypervisor 112. The hypervisor 112 includes snapshot components and runs a proxy in the host machine 106 to forward snapshot requests to the hypervisor 112. Because the hypervisor 112 runs in a high-privileged mode, the host machine 106 and/or other entities cannot alter the snapshot components either in memory or in persistent storage. Further, there is a hardware rooted trust chain associated with the snapshot generation by the hypervisor 112, and trust in the hypervisor 112 is established by the hardware 114 at launch. At the launch of the hypervisor 112 as the trusted computing base, the hardware 114 stores unalterable integrity indicators of the hypervisor 112 signifying that the hypervisor 112 was launched in a trusted manner. Accordingly, the challenger 102 may obtain verifiable snapshots of virtual machines executing in the virtualized environment while requiring minimal trust in the virtualized infrastructure 100.

For example, the challenger 102 may request a runtime state report of the guest machine 104. A reporting module 108 receives the request in the host machine 106. Because the reporting module 108 runs in the host machine 106, the reporting module 108 cannot be trusted. For example, malware 110 in the host machine 106 may subvert the reporting module 108. As such, the hypervisor 112 controls the snapshot generation process, and the reporting module 108 interacts with the hypervisor 112 using hypercalls.

Upon receiving a snapshot request from the challenger 102, the reporting module 108 passes the request to the hypervisor 112 by invoking a Copy-on-Write initialization hypercall. The reporting module 108 deposits sufficient memory within the hypervisor to store Copy-on-Write memory pages. In response to the hypercall, the hypervisor 112 pauses the guest machine 104 to initiate Copy-on-Write protection, which write-protects the address space of the guest machine 104 against access from any entity other than the hypervisor 112. To keep performance overhead reasonable, the hypervisor 112 pauses the guest machine 104 for a minimal duration and uses Copy-on-Write to allow the guest machine 104 to continue execution during the snapshot generation process. After resumed execution of the guest machine 104, any write request to a write-protected page in the address space of the guest machine 104 constitutes an access fault. At each access fault on a write-protected page, the hypervisor 112 copies the memory content of the faulted page (i.e., snapshots the faulted page) and computes and stores a hash of the contents of the faulted page before restoring write access permissions.

To generate a snapshot file, the reporting module 108 invokes a series of hypercalls to the hypervisor 112 sequentially requesting the contents of each memory page in the address space of the guest machine 104. The hypervisor 112 outputs the memory content of any faulted pages to the reporting module 108 and copies the content of any remaining memory pages of the guest machine 104 that were not modified during the Copy-on-Write process. The hypervisor 112 computes a hash over each remaining memory page and stores the hash in the hypervisor 112. The reporting module 108 receives the content of the memory pages of the guest machine 104 from the hypervisor 112 and writes the data corresponding to each memory page to a snapshot file stored in the host machine 106. Further, the hypervisor 112 copies a virtual CPU state associated with the guest machine 104 to obtain a consistent view of the runtime state of the guest machine 104. To capture a consistent state of the guest machine 104, the hypervisor may prevent modification to the guest machine 104 state unless the state is recorded as it was at the time of the snapshot request. The virtual CPU state of the guest machine 104 and the data corresponding to each memory page in the address space of the guest machine 104 are stored in the snapshot file in the host machine 106.

To protect the integrity of the snapshot file from the host 106, the hypervisor 112 generates a hash of each memory page in the address space of the guest machine 104 before the content of the memory page is output to the reporting module 108 for storage in the host machine 106. The hashes of the individual memory pages are stored in the hypervisor 112, which cannot be accessed by the host 106 due to the higher-privilege level of the hypervisor 112. The hypervisor 112 further generates a composite hash of all the individual hashes by concatenating individual hashes sequentially from the hash of a first memory page in the address space of the guest machine 104 to the hash of a last memory page. Generating the composite hash sequentially protects against a reordering attack. The virtual CPU state hash may be further included in the composite hash.

To protect the integrity of the composite hash, a hardware-rooted signature is used. After the reporting module 108 generates the snapshot file, the reporting module 108 sends a request to the hypervisor 112 to initiate a signing operation. The hypervisor 112 requests a quote from a trusted platform module (TPM) in the hardware 114 including integrity indicators of the trusted components (e.g., the hypervisor 112) and the composite hash. The quote uses a cryptographic signature, which ensures that any compromise of the integrity of the snapshot is detectable. The reporting module 108 outputs a verifiable snapshot 118 to the challenger 102. The verifiable snapshot 118 includes the snapshot file generated by the reporting module 108 and the signed quote output from the hypervisor 112.

After receiving the verifiable snapshot 118, the challenger 102 or a trusted third party may verify the integrity of the snapshot file and the snapshot generation process. To verify the integrity of the snapshot generation process, the challenger 102 uses the signed quote, which includes the integrity indicators of the trusted components. Adequate values for the integrity indicators verify that the composite hash is trustworthy and that the integrity of the hypervisor 112 was maintained during the snapshot generation process. To verify the integrity of the snapshot file, the challenger 102 computes a final composite hash over the memory contents of the snapshot file. An integrity measure for the final composite hash is compared to the integrity measure for the composite hash contained in the signed quote. If the integrity measures match, the challenger 102 received a trustworthy snapshot file. If the integrity measures do not match, the integrity of the snapshot is compromised, and the challenger 102 may take remedial action, such as discarding the snapshot, contacting the provider, and/or moving to a new provider.

Once the challenger 102 confirms that the verifiable snapshot 118 is trustworthy, the challenger 102 or other party may perform, for example, forensic analysis, migration, data recovery, malware detection, correctness validation, debugging, virtual machine health management, or other runtime analyses on the snapshot. The analysis of a trusted snapshot may inform a challenger 102 or other party whether, for example, the services running in the guest machine 104 are properly managed, new patches were applied correctly, and the integrity and confidentiality of the resources on the guest machine 104 are maintained. Further, analysis of a trusted snapshot by the challenger 102 increases accountability of the providers, administrators, and entities associated with the virtualized infrastructure 100.

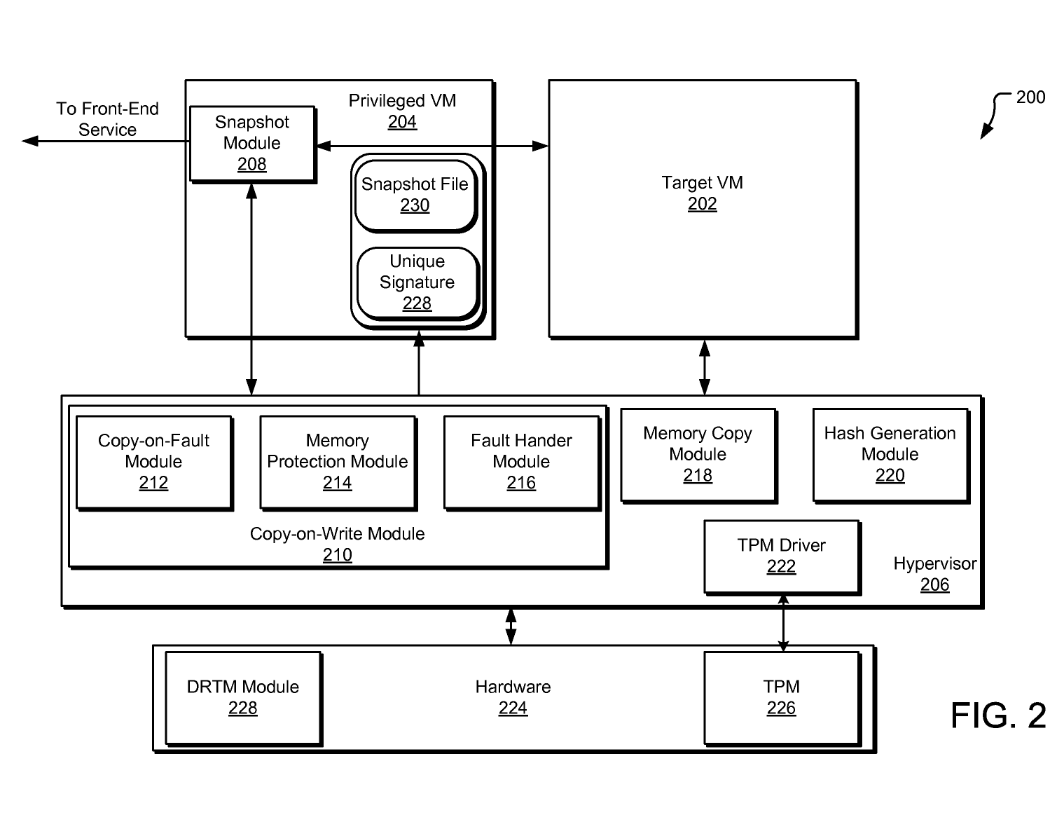

FIG. 2 illustrates an example infrastructure 200 for generating a verifiable snapshot. The virtualized infrastructure 200 includes a target virtual machine 202, a privileged virtual machine 204, and a hypervisor 206. The privileged virtual machine 204 may be any entity with elevated privileges that manages a target entity, which is an executing machine of which a snapshot is requested. For example, the privileged virtual machine 204 may be a root virtual machine, which provides services to one or more guest virtual machines including without limitation startup, snapshotting, memory and CPU resource management, I/O virtualization, peripheral access, save/restore, and live migration. A guest machine is a virtual machine running for a specific purpose, for example, as a virtual workload managed by the privileged virtual machine 204. The target virtual machine 202 may be any virtual machine running in the virtualized infrastructure 200, such as a guest virtual machine or a privileged virtual machine. The hypervisor 206 is a virtual machine monitor that isolates each guest virtual machine from another, allowing multiple guest virtual machines to operate concurrently on the privileged virtual machine 204. Additionally, the hypervisor 206 manages access to hardware 224, which includes a trusted platform module (TPM) 226 and a dynamic root of trust measurement (DRTM) module 228. The hypervisor 206 may be any module with a high-level privilege that is configured to generate authoritative reports of the runtime state of a target entity using an inherently trusted entity, such as the TPM 226.

The DRTM module 228 launches the hypervisor 206 in a trusted boot of the platform, for example, using trusted execution technology (TXT) before the privileged virtual machine 204 is launched. The trusted boot measures the state of trusted components (e.g., the hypervisor 206) and records integrity indicators of the trusted components in a non-repudiable fashion in Platform Configuration Registers (PCRs) in the TPM 226. In one implementation, the integrity values of the hypervisor 206 are recorded in non-resettable PCRs 17, 18, and 22 in the TPM 226. The integrity indicators of the trusted components may be used to verify that the trusted components (e.g., the hypervisor 206) were launched in a trusted manner and that the snapshot generation process may be trusted.

Snapshot generation is initiated when a challenger, which represents a person or entity requesting a snapshot of a virtual machine, sends a snapshot request to a front-end service (not shown) in the virtualized infrastructure 200. The snapshot request identifies the target virtual machine 202 by an identifier (e.g., VM_{guid}) assigned at the time of creation of the target virtual machine 202. The identifier protects against masquerading attacks by ensuring that the snapshot generation process is initiated for the target virtual machine 202 rather than another virtual machine. Any attempt by the privileged virtual machine 204 to modify the identifier in a masquerading attack can be easily detected during verification because the identifier is returned to the challenger with the snapshot for comparison. The identifier is concatenated with a non-predictable random nonce N in the snapshot request. The nonce is used to thwart replay attacks. Based on the identifier and the nonce, the front-end service locates the privileged virtual machine 204, which is the physical host on which the target virtual machine 202 is running. The front-end service sends the snapshot request to the privileged virtual machine 204.

A snapshot module 208 receives the snapshot request from the front-end service and forwards the snapshot request to the hypervisor 206. In one implementation, the hypervisor 206 pauses the target virtual machine 202 during the entirety of the snapshot process to obtain a consistent snapshot. In another implementation, the hypervisor 206 utilizes a Copy-on-Write module 210 to obtain a consistent snapshot and protect against tampering attacks.

The snapshot module 208 initiates a Copy-on-Write setup process using a hypercall to the hypervisor 206. The snapshot module 208 deposits sufficient memory in the hypervisor 206 to store any Copy-on-Write memory pages. In one implementation, the snapshot module 208 deposits memory in the hypervisor 206 equal to the amount of memory allocated to the target virtual machine 202. In another implementation, the snapshot module 208 deposits half of the memory of the privileged virtual machine 204 in the hypervisor 206. After the snapshot process is complete, the snapshot module 208 may invoke a cleanup hypercall to withdraw the deposited memory from the hypervisor 206.

To initiate the Copy-on-Write process, the hypervisor 206 virtualizes the memory of the target virtual machine 202 and the privileged virtual machine 204. The hypervisor 206 maps guest physical addresses (GPAs) to system physical addresses (SPAs) to manage memory translations via the hypervisor 206 owned, software based shadow page tables or second-level hardware page tables. The GPA-SPA map further stores access permissions for each SPA for the target virtual machine 202. To set up the Copy-on-Write on the target virtual machine 202, the hypervisor 206 pauses the target virtual machine 202 and a memory protection module 214 marks the memory pages of the target virtual machine 202 as read-only by iterating across the GPA-SPA. Because the privileged virtual machine 204 has full access to the memory pages of the target virtual machine 202, the memory protection module 214 write-protects memory pages of the target virtual machine 202 mapped in the page tables of the privileged virtual machine 204 using the GPA-SPA map of the privileged virtual machine 204. By write-protecting the memory pages of the target virtual machine 202 in the page tables of the privileged virtual machine 204, the state of the target virtual machine 202 is protected against attack or modification by the privileged virtual machine 204 during the snapshot.

The Copy-on-Write module 210 mediates on write performed by the target virtual machine 202 on write-protected memory pages. The Copy-on-Write module 210 provides persistent protection to the runtime state of the target virtual machine 202 by mediating operations that map and unmap memory pages in the address space of the target virtual machine 202. If there are any changes to a memory page that is write-protected and not previously copied, the Cop-on-Write module 210 copies and hashes the contents of the memory page before allowing any operation to proceed. When a guest virtual machine or the privileged virtual machine 204 requests an address of a write-protected memory page, a page fault occurs. If the target virtual machine 202 is a guest virtual machine, a page fault occurs from a guest virtual machine as part of its execution, and a page fault occurs from the privileged virtual machine 204 as part of privileged operations (e.g., I/O operations). If the target virtual machine 202 is a privileged virtual machine, page faults originate from the execution of the privileged virtual machine.

At each Copy-on-Write page fault during the snapshot generation process, a fault handler module 216 invokes a copy-on-fault module 212, which copies the content of the faulted memory page before restoring original access permissions. Additionally, the copy-on-fault module 212 computes a hash of the contents of the faulted page. The copy-on-fault module 212 stores the contents and the hash of the faulted page in protected memory in the hypervisor 206. After copying the faulted page's contents and hashing the faulted page, the hypervisor 206 allows changes to occur on the faulted page to enable continued execution of the target virtual machine 202. In one implementation, the target virtual machine 202 is the privileged virtual machine 204. After copying and hashing faulted memory pages, the fault handler module 216 restores original access permissions to the faulted page in the privileged virtual machine 204.

The snapshot module 208 sends an encrypted private portion of a signing key, such as an Attestation Identity Key (AIK), to the hypervisor 206, which loads the key into the TPM 226 via a TPM driver 222. The TPM 226 decrypts and stores the key during the snapshot generation process. The private portion of the signing key does not exist un-encrypted outside the TPM 226, which ensures that the quote is from the TPM 226.

To generate a snapshot 230 of the runtime state of the target virtual machine 202, the hypervisor 206 copies memory pages in the address space of the target virtual machine 202 through the Copy-on-Write module 210 and/or by servicing memory copy requests from the snapshot module 208 using a memory copy module 218. After initiating the Copy-on-Write process, the snapshot module 208 invokes a series of hypercalls sequentially requesting the contents of each memory page in the target virtual machine 202 from the memory copy module 218. In response, the memory copy module 218 copies the contents of any remaining memory pages in the target virtual machine 202 that were not copied during the Copy-on-Write process. Further, the memory copy module 218 computes a hash over the contents of each memory page. If a page was not previously copied during the Copy-on-Write process, the memory copy module 218 computes and stores the hash of the page in the hypervisor 206. Additionally, the hypervisor 206 snapshots the virtual CPU state of the target virtual machine 202. The virtual CPU state at the time of snapshotting is captured by storing all virtual CPU values at the initiation of the snapshot generation process. The hypervisor 206 outputs the data corresponding to the memory pages and virtual CPU state of the target virtual machine 202 to the snapshot module 208. The snapshot module 208 reads the data received from the memory copy module 218 corresponding to the requested memory page and writes the data to the snapshot 230, which may be without limitation a file, a structured memory, or a data stream.

To protect the integrity of the snapshot 230 from the privileged virtual machine 204, a hash generation module 220 generates hashes of the memory pages of the target virtual machine 202. In one implementation, the hash generation module 220 generates a hash, SHA-1, of each individual memory page present in the address space of the target virtual machine 202. The hash generation module 220 merges the individual hashes into a composite hash H_{composite} by concatenating individual hashes sequentially starting from the hash of the first memory page in the address space of the target virtual machine 202 and continuing until the last memory page. Generating the hash in order ensures that any reordering attacks are detected. The composite hash may be generated using linear hash concatenation. However, other hash generation techniques including without limitation Merkle hash trees may be employed. For example the composite hash may be generated according to the following:

H_{composite}=SHA−1(H₁∥H₂∥H₃ . . . ∥Hₘ)

M represents the total number of memory pages in the target virtual machine 202. The SHA-1 hash of the virtual CPU state may also be included in the composite hash H_{composite}. The hypervisor 206 associates the composite hash H_{composite} with the nonce N.

After the snapshot module 208 copies the memory contents of the target virtual machine 202 to the snapshot 230, the snapshot module 208 requests a unique signature 228 over the snapshot 230 from the hypervisor 206. The unique signature 228 is a quote of integrity indicators, including integrity indicators for the trusted components and the snapshot 230, that is signed using a cryptographic signature (e.g., the private AIK key) loaded into the TPM 226 by the hypervisor 206 before initiating the snapshot generation process. To obtain the unique signature 228 from the TPM 226, the hypervisor 206 resets and extends PCR₂₃ with H _{composite} corresponding to the nonce and the identifier:

PCR₂₃=Extend(0∥H_{composite})

The hypervisor 206 sends a quote request to the TPM 226 via the TPM driver 222 to obtain the unique signature 228:

TPM_Quote_{AIK}=(N∥VM_{guid})[PCRs]

AIK represents the private signing key loaded into the TPM 226 by the hypervisor 206, N represents the nonce, and VM_{guid} represents the identifier of the target virtual machine 202. PCRs is the set of PCRs={17, 18, 22, 23}, where PCR₁₇, PCR₁₈, and PCR₂₂ correspond to the integrity indicators of the trusted components (e.g., the hypervisor 206) and PCR₂₃ is the integrity measure for the snapshot 230. The generated quote is a cryptographic signature using the AIK loaded into the TPM 226 by the hypervisor 206 before initiating the snapshot generation process. The hypervisor 206 outputs the unique signature 228 to the snapshot module 208, and the snapshot module 208 sends a verifiable snapshot, including the snapshot 230 and the unique signature 228, to the front-end service. The challenger receives the verifiable snapshot from the front-end service.

A verifier, which may be without limitation the challenger, a trusted third party, or a computing system, verifies the integrity of the verifiable snapshot. In one implementation, the verification process is performed in software. The verifier checks that the signing key (AIK) is a valid key, for example, based on a certificate associated with the key, obtained out-of-band. The verifier compares the nonce and the identifier in the unique signature 228 to the original nonce and identifier to confirm there were no masquerading or replay attacks. To verify the integrity of the snapshot generation process, the verifier compares the values of PCR₁₇ , PCR₁₈ , and PCR₂₂ to values known by the verifier to correspond to a trusted hypervisor. The verifier extracts the composite hash Hₛₑₙₜ as the value of PCR₂₃ . The verifier computes a composite has, H_{local} over the memory contents of the snapshot 230 and performs an extend operation:

H_{final}=Extend(0∥H_{local})

If H_{final}=Hₛₑₙₜ, the snapshot 230 is trustworthy.

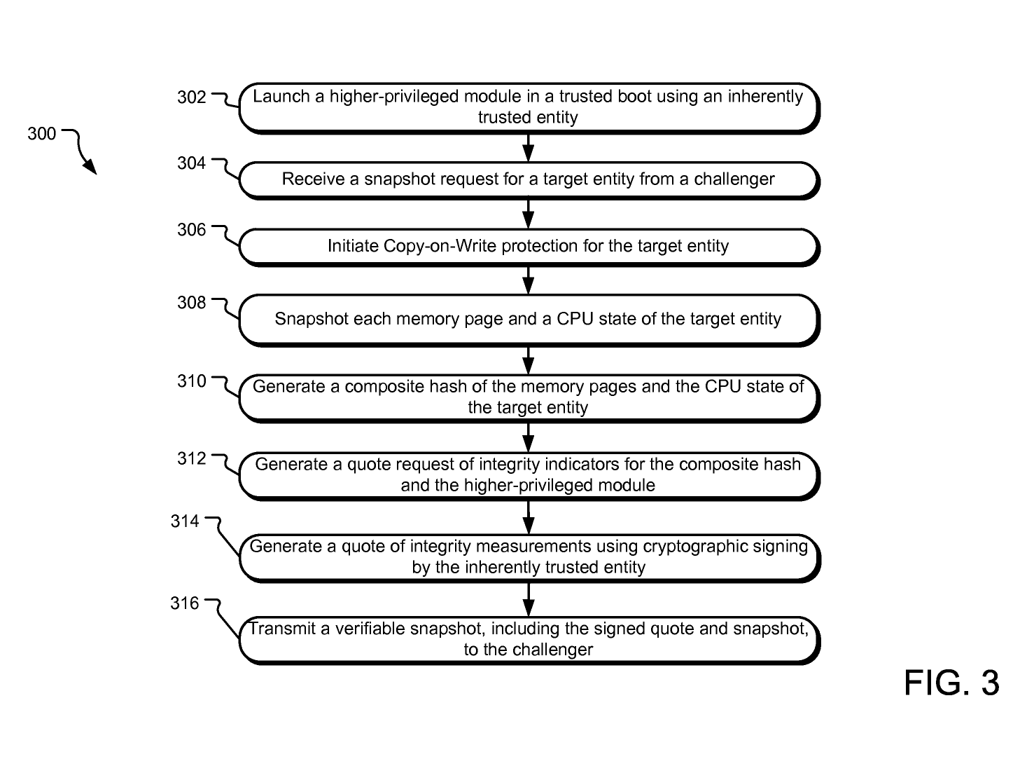

FIG. 3 illustrates example operations 300 for generating a verifiable snapshot. A launching operation 302 boots a higher-privileged module in a trusted manner using an inherently trusted entity. In one implementation, the higher-privileged module is a hypervisor and the inherently trusted entity is a trusted platform module (TPM). The launching operation 302 measures the state of trusted components, such as the higher-privileged module, and records integrity indicators of the trusted components in a non-repudiable fashion in the inherently trusted entity. The integrity indicators of the trusted components may be used to verify that the trusted components were launched in a trusted manner and that a snapshot generation process may be trusted.

A receiving operation 304 receives a snapshot request for a target entity from a challenger. The target entity may be any executing module. In one implementation, the target entity is a guest virtual machine. In another implementation, the target entity is a privileged virtual machine. Upon receiving the snapshot request, a protecting operation 306 initiates Copy-on-Write protection for the target entity. The protecting operation 306 deposits sufficient memory within the higher-privileged module to store Copy-on-Write memory pages, and the protecting operation 306 pauses the target entity. The Copy-on-Write protection write-protects the address space of the target entity against access from any entity other than the higher-privileged module. The protecting operation 306 resumes execution of the target entity. After resumed execution of the target entity, any write request to a write-protected page in the address space of the target entity constitutes an access fault. At each access fault on a write-protected page, the protecting operation 306 copies the memory content of the faulted page and computes and stores a hash of the contents of the faulted page before restoring write access permissions.

A snapshotting operation 308 copies the content of any remaining memory pages of the target entity that were not copied during the protecting operation 306. The snapshotting operation 308 computes a hash over each remaining memory page and stores the hash in the higher-privileged module. The hashes of the individual memory pages copied during the protecting operation 306 are additionally stored in the higher-privileged module. The content of the remaining memory pages and the content of the memory pages copied during the protecting operation 306 are stored in a snapshot. In one implementation, the snapshotting operation 308 copies and hashes a virtual CPU state associated with the target entity to obtain a consistent view of the runtime state of the target entity.

To protect the integrity of the snapshot generated in the snapshotting operation 308, a hashing operation 310 generates a composite hash of all the individual hashes computed during the protecting operation 306 and the snapshotting operation 308. The hashing operation 310 concatenates the individual hashes sequentially from the hash of a first memory page in the address space of the target entity to the hash of a last memory page. In one implementation, the virtual CPU state hash may be further included in the composite hash.

To protect the integrity of the snapshot and the trusted components, a generating operation 312 generates a quote request of integrity indicators for the composite hash and the higher-privileged module. A quoting operation 314 uses a cryptographic signature, which includes the integrity indicators. The signing operation 314 ensures that any compromise to the integrity of the snapshot or the trusted components is detectable. A transmitting operation 316 outputs a verifiable snapshot to the challenger. The verifiable snapshot includes the snapshot and the signed quote.

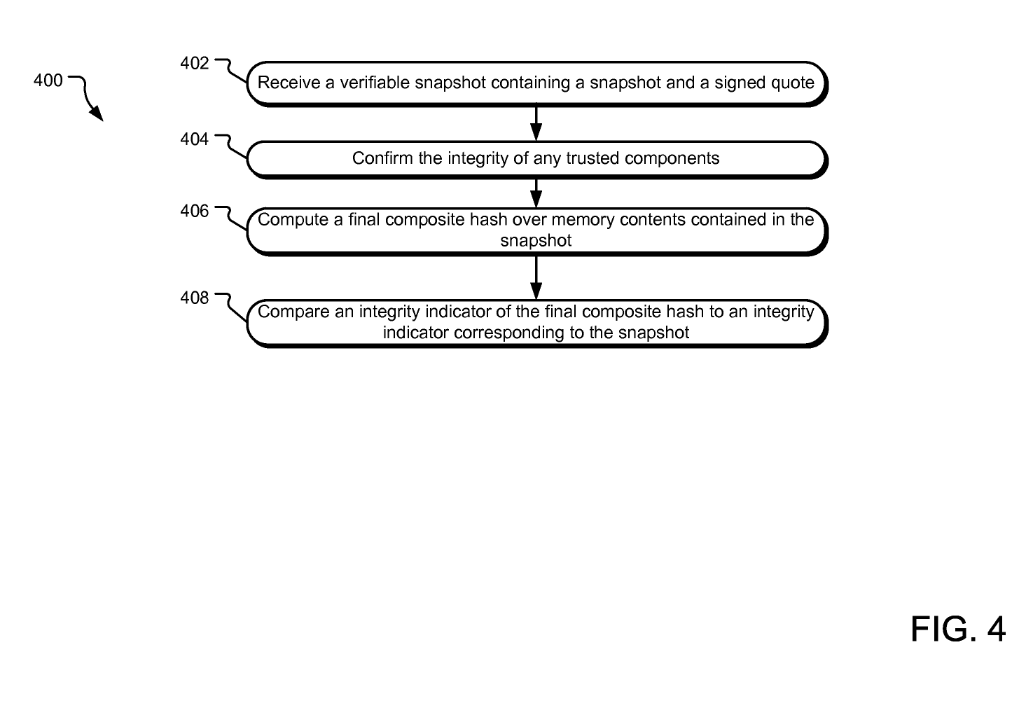

FIG. 4 illustrates example operations 400 for verifying the integrity of a snapshot. A receiving operation 402 receives a verifiable snapshot containing a snapshot and a signed quote. The verifiable snapshot may be used to verify the integrity of the received snapshot and any trusted components used to generate the snapshot. A confirming operation 404 uses the signed quote to verify the integrity of the trusted components. In one implementation, the trusted components include a higher-privileged module, such as a hypervisor. The signed quote includes integrity indicators of the trusted components. Adequate values for the integrity indicators verify that the integrity of the trusted components was maintained during the snapshot generation process.

The signed quote additionally includes an integrity indicator for the snapshot. To verify the integrity of the snapshot file, a hashing operation 406 computes a final composite hash over the memory contents of the snapshot. A comparing operation 408 compares an integrity indicator for the final composite hash to the integrity indicator corresponding to the snapshot in the signed quote. If the integrity indicators match, the snapshot is trustworthy.

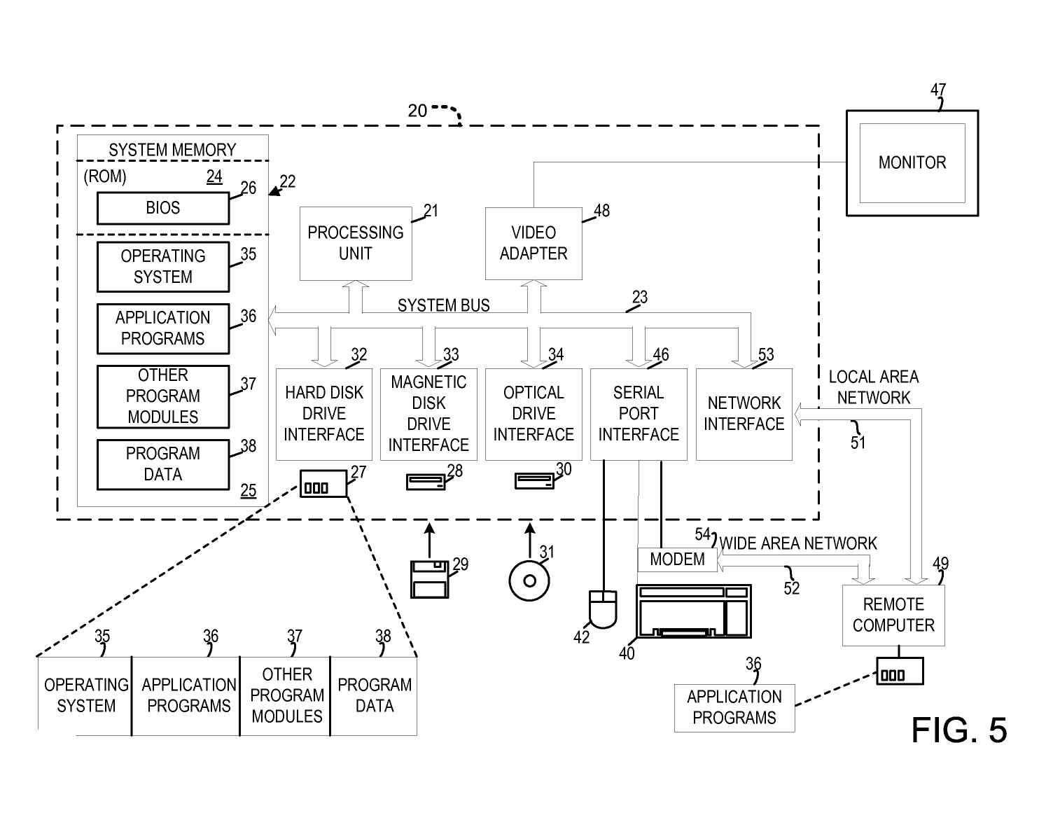

FIG. 5 illustrates an example system that may be useful in implementing the described technology. The example hardware and operating environment of FIG. 5 for implementing the described technology includes a computing device, such as general purpose computing device in the form of a gaming console, multimedia console, or computer 20, a mobile telephone, a personal data assistant (PDA), a set top box, or other type of computing device. In the implementation of FIG. 5, for example, the computer 20 includes a processing unit 21, a system memory 22, and a system bus 23 that operatively couples various system components including the system memory to the processing unit 21. There may be only one or there may be more than one processing unit 21, such that the processor of computer 20 comprises a single central-processing unit (CPU), or a plurality of processing units, commonly referred to as a parallel processing environment. The computer 20 may be a conventional computer, a distributed computer, or any other type of computer; the invention is not so limited.

The system bus 23 may be any of several types of bus structures including a memory bus or memory controller, a peripheral bus, a switched fabric, point-to-point connections, and a local bus using any of a variety of bus architectures. The system memory may also be referred to as simply the memory, and includes read only memory (ROM) 24 and random access memory (RAM) 25. A basic input/output system (BIOS) 26, containing the basic routines that help to transfer information between elements within the computer 20, such as during start-up, is stored in ROM 24. The computer 20 further includes a hard disk drive 27 for reading from and writing to a hard disk, not shown, a magnetic disk drive 28 for reading from or writing to a removable magnetic disk 29, and an optical disk drive 30 for reading from or writing to a removable optical disk 31 such as a CD ROM, DVD, or other optical media.

The hard disk drive 27, magnetic disk drive 28, and optical disk drive 30 are connected to the system bus 23 by a hard disk drive interface 32, a magnetic disk drive interface 33, and an optical disk drive interface 34, respectively. The drives and their associated computer-readable media provide nonvolatile storage of computer-readable instructions, data structures, program engines and other data for the computer 20. It should be appreciated by those skilled in the art that any type of computer-readable media which can store data that is accessible by a computer, such as magnetic cassettes, flash memory cards, digital video disks, random access memories (RAMs), read only memories (ROMs), and the like, may be used in the example operating environment.

A number of program engines may be stored on the hard disk, magnetic disk 29, optical disk 31, ROM 24, or RAM 25, including an operating system 35, one or more application programs 36, other program engines 37, and program data 38. A user may enter commands and information into the personal computer 20 through input devices such as a keyboard 40 and pointing device 42. Other input devices (not shown) may include a microphone, joystick, game pad, satellite dish, scanner, or the like. These and other input devices are often connected to the processing unit 21 through a serial port interface 46 that is coupled to the system bus, but may be connected by other interfaces, such as a parallel port, game port, or a universal serial bus (USB). A monitor 47 or other type of display device is also connected to the system bus 23 via an interface, such as a video adapter 48. In addition to the monitor, computers typically include other peripheral output devices (not shown), such as speakers and printers.

The computer 20 may operate in a networked environment using logical connections to one or more remote computers, such as remote computer 49. These logical connections are achieved by a communication device coupled to or a part of the computer 20; the invention is not limited to a particular type of communications device. The remote computer 49 may be another computer, a server, a router, a network PC, a client, a peer device or other common network node, and typically includes many or all of the elements described above relative to the computer 20, although only a memory storage device 50 has been illustrated in FIG. 5. The logical connections depicted in FIG. 5 include a local-area network (LAN) 51 and a wide-area network (WAN) 52. Such networking environments are commonplace in office networks, enterprise-wide computer networks, intranets and the Internet, which are all types of networks.

When used in a LAN-networking environment, the computer 20 is connected to the local network 51 through a network interface or adapter 53, which is one type of communications device. When used in a WAN-networking environment, the computer 20 typically includes a modem 54, a network adapter, a type of communications device, or any other type of communications device for establishing communications over the wide area network 52. The modem 54, which may be internal or external, is connected to the system bus 23 via the serial port interface 46. In a networked environment, program engines depicted relative to the personal computer 20, or portions thereof, may be stored in the remote memory storage device. It is appreciated that the network connections shown are example and other means of and communications devices for establishing a communications link between the computers may be used.

In an example implementation, a snapshot module, one or more guest virtual machines, one or more privileged virtual machines, a hypervisor, and other engines and services may be embodied by instructions stored in memory 22 and/or storage devices 29 or 31 and processed by the processing unit 21. Snapshot files, hash, and other data may be stored in memory 22 and/or storage devices 29 or 31 as persistent datastores.

The embodiments of the invention described herein are implemented as logical steps in one or more computer systems. The logical operations of the present invention are implemented (1) as a sequence of processor-implemented steps executing in one or more computer systems and (2) as interconnected machine or circuit engines within one or more computer systems. The implementation is a matter of choice, dependent on the performance requirements of the computer system implementing the invention. Accordingly, the logical operations making up the embodiments of the invention described herein are referred to variously as operations, steps, objects, or engines. Furthermore, it should be understood that logical operations may be performed in any order, unless explicitly claimed otherwise or a specific order is inherently necessitated by the claim language.

The above specification, examples, and data provide a complete description of the structure and use of exemplary embodiments of the invention. Since many embodiments of the invention can be made without departing from the spirit and scope of the invention, the invention resides in the claims hereinafter appended. Furthermore, structural features of the different embodiments may be combined in yet another embodiment without departing from the recited claims.

What is claimed is:

1. A method comprising:
initiating a privileged module in a trusted manner using a trusted platform module;
generating a snapshot of a runtime state of a target virtual machine using the privileged module; and
generating a quote using cryptographic signing by the trusted platform module, the quote including a first integrity indicator associated with the privileged module and a second integrity indicator associated with the snapshot.

2. The method of claim 1 further comprising:
transmitting the generated quote and the generated snapshot to a challenger.

3. The method of claim 2 wherein the operation of generating a quote comprises:
encrypting at least the first integrity indicator and the second integrity indicator using a private key of the trusted platform module for generating the quote, a public decryption key associated with the private key being accessible by the challenger.

4. The method of claim 1 wherein the operation of generating a snapshot comprises:
protecting each memory page in the target virtual machine from write access; and
copying each memory page in the target virtual machine associated with a write access fault.

5. The method of claim 1 wherein the operation of generating a snapshot comprises:
computing a composite hash of the runtime state of the target virtual machine.

6. The method of claim 5 wherein the operation of generating a quote comprises:
computing a hash of each individual memory page of the target virtual machine;
computing a hash of a virtual central processing unit state of the target virtual machine; and
merging the hashes of each individual memory page and the hash of the virtual central processing unit state into the composite hash of the runtime state of the target virtual machine.

7. The method of claim 1 further comprising:
computing a composite hash over the snapshot; and
comparing an integrity indicator of the composite hash to the second integrity indicator associated with the snapshot.

8. The method of claim 1 further comprising:
comparing the first integrity indicator associated with the privileged module to known values corresponding to a valid privileged module.

9. One or more tangible computer-readable storage media storing computer-executable instructions for performing a computer process on a computing system, the computer process comprising:
initiating a privileged module in a trusted manner using a trusted entity;
generating a snapshot of a runtime state of a target machine using the privileged module; and
generating a quote using cryptographic signing by the trusted entity, the quote including a first integrity indicator associated with the privileged module and a second integrity indicator associated with the snapshot.

10. The one or more tangible computer-readable storage media of claim 9 wherein the computer process comprises further comprising:
transmitting the generated quote and the generated snapshot to a challenger.

11. The one or more tangible computer-readable storage media of claim 10 wherein the operation of generating a quote comprises:
encrypting at least the first integrity indicator and the second integrity indicator using a private key of the trusted entity for generate the quote, a public decryption key associated with the private key being accessible by the challenger.

12. The one or more tangible computer-readable storage media of claim 9 wherein the trusted entity is a trusted platform module.

13. The one or more tangible computer-readable storage media of claim 9 wherein the target machine is a virtual machine.

14. The one or more tangible computer-readable storage media of claim 9 wherein the operation of generating a snapshot comprises:
protecting each memory page in the target machine from write access; and
copying each memory page in the target machine associated with a write access fault.

15. The one or more tangible computer-readable storage media of claim 9 wherein the operation of generating a snapshot comprises:
computing a composite hash of the runtime state of the target machine.

16. The one or more tangible computer-readable storage media of claim 15 wherein the operation of generating a quote comprises:
computing a hash of each individual memory page of the target machine;
computing a hash of a virtual central processing unit state of the target machine; and
merging the hashes of each individual memory page and the hash of the virtual central processing unit state into the composite hash of the runtime state of the target machine.

17. The one or more tangible computer-readable storage media of claim 9 wherein the computer process further comprises:
computing a composite hash over the snapshot; and
comparing an integrity indicator of the composite hash to the second integrity indicator associated with the snapshot.

18. A system comprising:
a privileged module executable by a processor and configured to generate a snapshot of a runtime state of a target machine;
a trusted entity configured to initiate the privileged module in a trusted manner, the privileged module being further configured to generate a quote using cryptographic signing by the trusted entity, the quote including a first integrity indicator associated with the privileged module and a second integrity indicator associated with the snapshot.

19. The system of claim 18 further comprising:
a snapshot module configured to transmit the generated quote and the generated snapshot to a challenger.

20. The system of claim 19 wherein the trusted entity is further configured to encrypt at least the first integrity indicator and the second integrity indicator using a private key of the trusted entity for generating the quote, a public decryption key associated with the private key being accessible by the challenger.
